(19) United States
(12) Patent Application Publication
(10) Pub. No.: US 2012/0078666 A1
(43) Pub. Date: Mar. 29, 2012

(54) SYSTEMS AND METHODS FOR INSURING CONTINGENT LIABILITIES

(76) Inventors: José Ronoel Piccin, Sao Paulo (BR); Alberto Gomes Pinho, Sao Paulo (BR); Edison Carlos FERNANDES, Sao Paulo (BR); João Carlos Meza, Sao Paulo (BR)

(21) Appl. No.: 13/184,236

(22) Filed: Jul. 15, 2011

Related U.S. Application Data
(60) Provisional application No. 61/364,694, filed on Jul. 15, 2010.

(51) Int. Cl. G06Q 40/08

(52) U.S. Cl. 705/4

(57) ABSTRACT

Disclosed herein are insurance systems and methods to provide insurance for contingent liabilities. An insurance system can customize an insurance product for a company to cover a contingent liability, wherein the cost of the insurance product considers various factors, including, for example, likelihood of the contingency associated with the contingent liability, the estimated value of the obligation potentially arising from the contingent liability, and the estimated timeframe until the contingency is resolved. Purchasing the insurance product can enable the company to more accurately reflect its financial position in a balance statement and, thus, to more appropriately disburse funds to shareholders. Other embodiments of the insurance systems and methods are also disclosed.

### CROSS-REFERENCE TO RELATED APPLICATIONS

This application claims a benefit, under 35 U.S.C. §119(e), of U.S. Provisional Application Ser. No. 61/364,694, filed 15 Jul. 2010, the entire contents and substance of which are hereby incorporated by reference as if fully set forth below.

### FIELD OF THE INVENTION

Various embodiments of the present invention relate to insurance and, more particularly, to systems and methods for insuring contingent liabilities, such as lawsuits.

### BACKGROUND

An uncertain or potential obligation of a company is known as a contingent liability, and such a liability can prove problematic for accounting purposes. Contingent liabilities can arise from, for example, legal disputes, environmental contamination events, and product warranties, all of which can have uncertain outcomes that may give rise to obligations. According to the international accounting standards of both the International Accounting Standards Board and the Financial Accounting Standards Board, a company should periodically review its present obligations. This accounting of present obligations includes consideration of contingent liabilities, which should in some cases be accounted for in the present even though dependent on uncertain future events, also known as contingencies.

Similarly, banks and other organizations seeking to comply with default provisions and to enforce the Basileia II and II rules, concerning Allowances for Doubtful Accounts, must provide entries on their balance sheets reflecting the applicable contingent liabilities.

A subjective assessment of the probability of a contingency is required to properly account for a contingent liability based on the contingency. A contingency can be deemed to be probable, reasonably possible, or remote. The contingent liability should be recorded on a company's balance sheet and in the company's accounts when the contingent liability is both probable and reasonably estimable. In that case, a loss is recorded and a liability is established in advance of the occurrence of the associated contingency. As a result, any disbursements made to shareholders of the company are reduced in light of the contingent liability.

When a contingent liability is deemed to be reasonably possible or probable but not reasonably estimable, the company has no obligation to create a journal entry, but the company should disclose existence of the contingent liability in explanatory notes. If the occurrence of the relevant uncertain future event is remote, however, no journal entry is made in the company's accounts and no funds are set aside to cover payment of an obligation resulting from the contingent liability.

Defining the likelihood of an uncertain event is a partially subjective process undertaken by officers of the company, in conjunction with experts when appropriate. Because determining the likelihood of future events can affect whether a contingent liability is disclosed, and thus the amount of profits distributed to shareholders, this determination usually generates conflict among managers, between managers and independent auditors, between managers and shareholder controllers, and between managers and minority shareholders.

### SUMMARY

There is a need for systems and methods to reduce or eliminate disputes over the likelihood of uncertain events related to contingent liabilities and Allowance for Doubtful Accounts, and to more certainly reflect contingent liabilities on income and balance statements. It is to such systems and methods that various embodiments of the present invention are directed.

Briefly described, various embodiments of the present invention are insurance systems and methods for offering and providing insurance products to cover contingent liabilities. An exemplary insurance system of the present invention can eliminate, or at least mitigate, potential conflict to determine the likelihood of a contingent liability, and can ensure that a proper amount of profits are withheld from shareholder disbursements.

The insurance system can offer and provide insurance for contingent liabilities. In some embodiments, only contingent liabilities for which likelihoods have not or cannot be determined are insurable. In other embodiments, only contingent liabilities with previously determined likelihoods are insurable, and the insurance can be limited to those contingent liabilities with select likelihoods, such as only those that are reasonably possible. In still alternative embodiments, however, contingent liabilities with both known and unknown likelihoods can be insurable according to the present invention.

An insurance product provided by the insurance system can be a present obligation having a known value, and can thus be entered onto a company's accounts with a greater degree of certainty than can a contingent liability. The insurance system can determine a cost for the insurance product, and the company can pay that cost to reduce the risk and uncertainty inherent in the contingent liability. The present obligation of the insurance can thus replace the uncertain present obligation of the contingent liability. Accordingly, the balance sheet can reflect the insurance instead of reflecting the contingent liability, and shareholder disbursements can be made in consideration of the insurance expense instead of in consideration of the contingent liability.

These and other objects, features, and advantages of the insurance system will become more apparent upon reading the following specification in conjunction with the accompanying drawing figures.

### BRIEF DESCRIPTION OF THE FIGURES

FIG. 1 illustrates a diagram of an operating environment of an insurance system, according to an exemplary embodiment of the present invention.

FIG. 2 illustrates a diagram of a computer architecture of a client computer of the insurance system, according to an exemplary embodiment of the present invention.

FIG. 3 illustrates a diagram of a computer architecture of a server of the insurance system, according to an exemplary embodiment of the present invention.

FIG. 4 illustrates a method of providing an insurance product for a contingent liability, according to an exemplary embodiment of the present invention.

FIGS. 5A-10B illustrate various exemplary financial scenarios, according to an exemplary embodiment of the present invention.

### DETAILED DESCRIPTION

To facilitate an understanding of the principles and features of the invention, various illustrative embodiments are explained below. In particular, the invention is described in the context of being an insurance system for offering and providing insurance to cover the risks associated with contingent liabilities, such as unsettled legal disputes. Embodiments of the invention, however, are not limited to contingent liabilities. Rather, exemplary embodiments may offer and provide insurance for various types of liabilities and obligations. For example, and not limitation, an alternative embodiment of the invention can insure doubtful receivable accounts. In that case, an insurance product of the present invention can protect a company against the risk of possible defaults. For shareholders and managers, the provision for accounts receivable may be an essential reference for profits, and thus, it may be dangerous to underestimate or overestimate the value of accounts that will default. Thus, an embodiment of the present invention can provide insurance to protect against potential defaults, as well as to protect against other uncertain occurrences.

The elements described hereinafter as making up the invention are intended to be illustrative and not restrictive. Many suitable elements that would perform the same or similar functions as the elements described herein are intended to be embraced within the scope of the invention. Other elements not described herein can include, but are not limited to, for example, similar or analogous elements developed after development of the invention.

Various embodiments of the present invention can be insurance systems and methods for offering and providing insurance to companies for contingent liabilities. According to an exemplary embodiment of the present invention, an insurance system can offer and provide an insurance product to cover a contingent liability, thus ensuring payment of dividends to shareholders. When a company insures a contingent liability according to an embodiment of the present invention, the contingent liability need not be recognized as a provision and, thus, need not reduce the company's recognized profits.

An exemplary insurance product of the present invention, for a contingent liability, can provide the following beneficial features and results:
reduction in the impact of the oscillation of estimated results of the contingent liability;
accurate and timely distribution of profits in the form of dividends, due to equalization between cash flow and expectations; and
security for administrators in the analysis of risk factors.

In a capital market, the following benefits can also be provided by an exemplary insurance product for a contingent liability:
security to analysts, as a result of increased stability in company profit expectations; and
maintenance of value and liquidity of shares of the company, stemming from the increased stability.

Referring now to the figures, in which like reference numerals represent like parts throughout the views, various embodiment of the insurance systems and method will be described in detail.

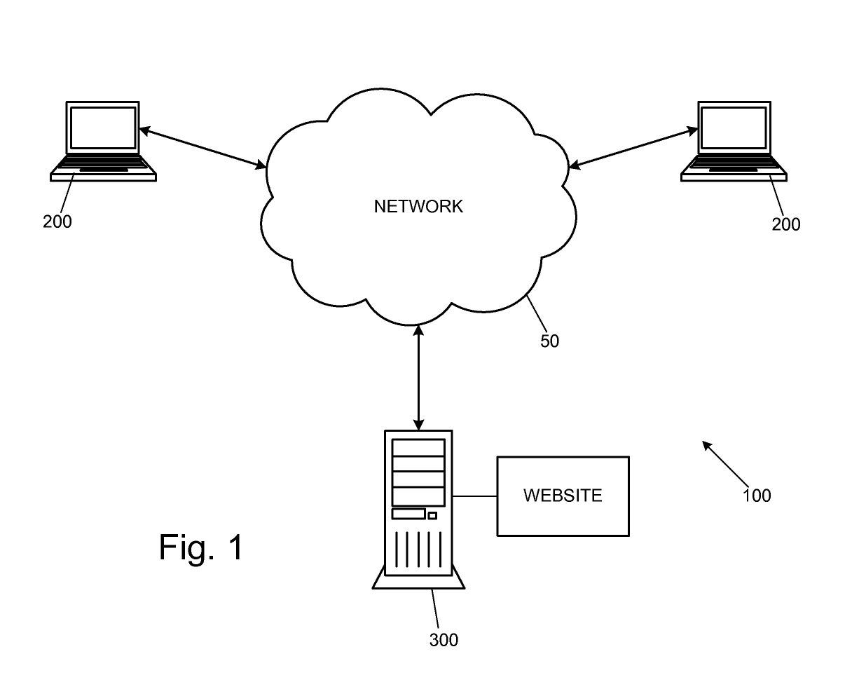

FIG. 1 illustrates an insurance system provided by one or more computing devices, according to an exemplary embodiment of the present invention. The insurance system 100 can be embodied in one or more computer-readable media for execution by a computer processor. Thus, as shown in FIG. 1, the insurance system 100 can comprise a client 200, which can optionally be in communication with a server 300 over a network 50.

A requesting entity can submit to the client 200 information about a contingent liability sought to be covered by an insurance product. In some embodiments of the insurance system 100, the client 200 can comprise a computer-readable medium containing instructions for processes of the insurance system 100. In some other embodiments, the client 200 can be in communication with a server 300 over a network 50, and the server 300 can comprise the computer-readable medium with instructions for processes of the insurance system 100. In that case, the client 200 can comprise an application or web client for communicating with the server 300 over the network 50. In still other embodiments, both the client 200 and the server 300 can comprise some portion of the instructions for the insurance system 100.

The requesting entity can be, for example, an insurance agent or a person associated with the company seeking insurance. After the requesting entity submits information about the contingent liability, the client 200 can return a proposed insurance product designed to cover the contingent liability and to meet the company's needs. Where the client 200 independently contains software to customize an insurance product, the client 200 can execute the software to do so. If necessary, however, the client 200 can communicate with the server 300 to determine an appropriate insurance product.

The insurance product can include an insurance premium. The insurance premium is a cost payable from an insured to an insurer, generally on a recurring basis, such as a monthly basis. In an exemplary embodiment of the insurance system 100, calculating a premium for an insurance product can require manual analysis, automated analysis, or both. One or more persons associated with the insurance system 100, such as an insurance agent or other personnel of an insurance company, may provide relevant details to the insurance system 100 to enable calculation of the premium. For example, as will be discussed further below, the insurance premium can depend on estimations and subjective analysis, which may require manual intervention. In some further embodiments, the one or more persons may calculate the premium manually and enter the premium into the insurance system 100. These relevant details can be provided to the server 300, which can transmit the details to the client 200, or can calculate the premium and then transmit the premium and other information about the insurance product to the client 200.

After an insurance product for the contingent liability is determined, the insurance product, including scope of coverage and cost of the product, can be presented to the requesting entity through the client 200. At that point, the requesting entity can indicate to the client 200 that the requesting entity desires to accept the insurance product, reject the insurance product, or modify aspects of the insurance product. The client 200 can receive the requesting entity's indication. If the insurance product is rejected, no insurance need be established for the contingent liability. If the requesting entity attempts to modify the insurance product, then the client 200 can determine a new, appropriate insurance product based on the requested modifications and the information originally received about the contingent liability.

If the insurance product is accepted, the client 200 can initiate procedures necessary to establish insurance coverage using the terms of the insurance product. These procedures can include, for example, underwriting an insurance policy. In some instances, reinsurance can be sought to cover the insurance, in which case a reinsurer may share the risk of the contingent liability with the insurer.

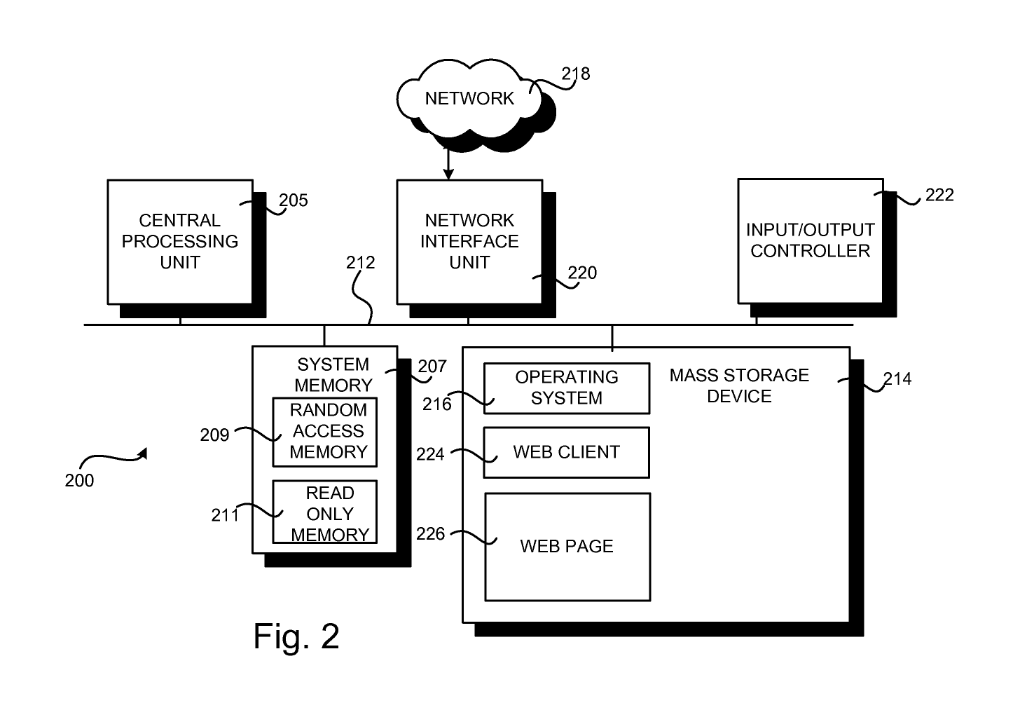

The client 200 can be, for example, one or more computer processes, computer applications, or computing devices. FIG. 2 illustrates a computer architecture for an exemplary client 200, in accordance with an exemplary embodiment of the present invention. The client 200 can be used to access a website served by the server 300 or to otherwise communicate with the server 300. As shown in FIG. 2, the client 200 can comprise a central processing unit 205 (“CPU”) and one or more system memories 207, such as a random access memory 209 (“RAM”) and a non-volatile memory, such as a read-only memory (“ROM”) 211. The client 200 can further comprise a system bus 212 coupling together the memory 207, the processing unit 205, and various other components. A basic input/output system containing routines to assist in transferring information between components of the client 200 can be stored in the ROM 211.

The client 200 can comprise, or can be associated with, various forms of computer-readable media. One such form of computer-readable media can be embodied in a mass storage device 214. The mass storage device 214 can store an operating system 216, application programs, and other program units, such as units configured to effect processes of the insurance system 100. The mass storage device 214 can be connected to the CPU 205 through a mass storage controller (not shown) connected to the bus 212. The mass storage device 214 can provide non-volatile storage for the client 200.

Computer-readable media can include computer storage media, such as volatile and non-volatile, removable and non-removable media implemented in many methods or technologies for storage of information, such as computer-readable instructions, data structures, program units, or other data. Computer storage media can include, but is not limited to, RAM, ROM, EPROM, EEPROM, flash memory, other solid state memory technology, CD-ROM, digital versatile disks (“DVD”), other optical storage, magnetic cassettes, magnetic tape, magnetic disk storage, other magnetic storage devices, or many other media that can be used to store data accessible by the client 200 or the server 300. Computer-readable instructions in the form of software on the storage media of the client 200 can include, for example, instructions for implementing processes, preferably client-side processes, of the insurance system 100.

According to various embodiments of the present invention, the client 200 can operate in a networked environment using logical connections to remote computers, such as the server 300, through a network 50, such as the Internet. The client 200 can connect to the network 50 through a network interface unit 220 connected to the bus 212. It will be appreciated that the network interface unit 220 can also be utilized to connect to other types of networks and remote computer systems.

The client 200 can also include an input/output controller 222 for receiving and processing input from a number of input devices, including a keyboard, mouse, or electronic stylus. The input devices can be used by the requesting entity to submit information about the contingent liability to the client 200. The input/output controller 222 can provide output to a display screen, a printer, or other type of output device.

A number of program units and data files can be stored in the mass storage device 214 and RAM 209 of the client 200. Such program units and data files can also include an operating system 216 suitable for controlling operations of a networked personal computer. A web browser application program, or web client 224, can also be stored on the mass storage device 214 and the RAM 209. The web client 224 can comprise an application program for requesting and rendering web pages 226 created in Hypertext Markup Language (“HTML”) or other markup or browser-readable languages. The web client 224 can be capable of executing client side objects, as well as scripts through the use of a scripting host. The scripting host can execute program code expressed as scripts within the browser environment. If the server 300 services a website through which the insurance system 100 can operate, then the web client 224 can communicate with the server 300 through that website. Other forms of communication between the client 200 and the server 300 over the network 50 can also or alternatively be provided to provide operation of the insurance system 100.

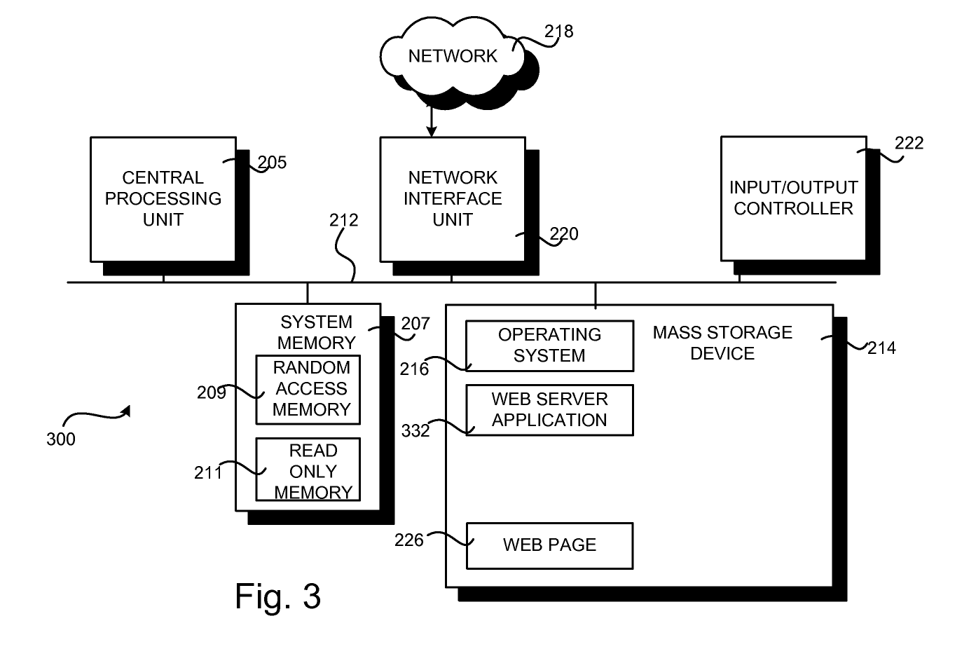

Referring now to FIG. 3, a server 300 utilized in various exemplary embodiments of the insurance system 100 is illustrated. The server 300 can receive and respond to requests from the client 200 for operation of the insurance system 100. Those skilled in the art will recognize that the server 300 illustrated in FIG. 3 is an exemplary server configuration and can be modified to accommodate various embodiments of the insurance system 100. As shown in FIG. 3, the server 300 can include many of the conventional computing components included in the client 200 and described above with respect to FIG. 2. In particular, the server 300 can include a processing unit 205, a network interface unit 220 connected to the network 50, a system memory 207, and a mass storage device 214, such as the storage device 330.

The mass storage device 214 utilized by the server 300 can typically be operative to store an operating system 216 suitable for servicing a website, if the insurance system 100 is effected through a website, and for controlling operations of a server computer. The mass storage device 214 and its associated computer-readable storage media can provide non-volatile storage for the server 300. Computer-readable instructions in the form of software on computer-readable storage media of the server 300 can include, for example, instructions for implementing processes, preferably server-side processes, of the insurance system 100.

In some embodiments, the server 300 can utilize a web server application 332. The web server application 332 may receive and respond to requests from web clients 224 at remote computers, such as the client 200, for web pages 226 located at or accessible to the server 300. It will be appreciated that web pages 126 can include both those pages stored statically and utilizing only HTML, as well as pages generated dynamically through use of server-side scripting technologies.

Table 1, below, illustrates an exemplary method of calculating a premium for an insurance product of the present invention. As exemplified in Table 1, an insurance premium can be calculated based, at least partially, on a timing factor and a probability of loss factor. In some embodiments of the insurance system 100, one or more persons associated with the insurance system 100 can calculate the premium or provide the insurance system 100 with information sufficient to calculate the insurance premium. For example, such persons can provide to the insurance system 100 the values, or indicia of the values, of the timing and probability of loss factors.

TABLE 1

| | Probable Loss | Possible Loss | Remote Loss |
|---|---|---|---|
| Short Term | more than 5% of the | 4-5% of the | 1-2% of the |
| | maximum value of | maximum value of | maximum value of |
| | the contingency | the contingency | the contingency |
| Long Term | 3-4% of the | 2-3% of the | less than 1% of the |
| | maximum value of | maximum value of | maximum value of |
| | the contingency | the contingency | the contingency |

Various analytical methods of can be utilized to calculate the insurance premium. For example, and not limitation, a formula can be utilized by the insurance system 100 to calculate the premium, and the formula can generally be based on an estimated term of the contingency, probability of loss, and estimated maximum value of the contingency. In some embodiments, the formula can be used as only a baseline estimate, where the premium calculated by the formula can be tentative only and can be modified before being finalized. The premium can generally be in the range of 2-5% of the maximum value of the contingency, but can fall outside if this range in some circumstances.

In some embodiments, the formula assigns to the premium a value that is a linear combination of the probability of loss factor and the timing factor, multiplied by the estimated maximum value of the contingency. This need not be the case, however. Alternatively, for example, a polynomial or exponential formula may also be used, or a human being can subjectively determine premiums on a case-by-case basis.

The timing factor can represent an estimated time until the contingency is resolved, and the probability of loss factor can represent a probability that the contingency will be realized. Each of these factors can be based on a historical analysis or other type of subjective analysis of one or more characteristics of the contingency in question. For example, and not limitation, a historical analysis can be performed on past contingencies having similar characteristics, so as to establish educated estimates for timing and loss probability for the contingency in question.

Additionally, each of the timing factor and the probability of loss factor can fall into either a continuous range or a discrete set. For example, in some exemplary embodiments, the probability of loss factor can be restricted to the set of [probable, possible, remote], and each of these three possible values can be assigned a numerical value for the purpose of calculating the premium. In some other exemplary embodiments, the probability of loss factor can be a percentage in the continuous range of whole numbers, or alternatively real numbers, between zero and one hundred. Analogously, the timing factor can also fall into a continuous range, such as an actual estimated time until the contingency is resolved, or can be assigned from a discrete set. For example, and not limitation, the timing factor can be assigned a first value if the contingency is deemed to be short term and can be assigned a second value if the contingency is deemed to be long term.

In some embodiments of the insurance system 100, the premium can be variable. In that case, periodic recalculations can be performed by the insurance system 100, or associated persons, based on new values of the timing factor, the probability of loss factor, or both. These recalculations can be scheduled, for example, on a monthly or annual basis, or they can be performed on demand when it is manually determined that relevant circumstances have changed. For example, in the case of a lawsuit, if it appears that a covered lawsuit will continue for a longer period than expected, or if a precedential court decision has been issued since the previous premium calculation, then the applicable premium for coverage of that lawsuit can be recalculate to account for the changed circumstances.

If the contingency sought to be covered by an insurance product is a lawsuit or other legal dispute, the timing factor and the probability of loss factor can be related to previous outcomes of similar cases. Particularly, with respect to the probability of loss factor, case decisions having prudential weight over the lawsuit sought to be covered can be given more weight than non-precedential decisions. The estimated maximum value of the contingency, in the case of a lawsuit, can be the total amount sought by the other party in the lawsuit.

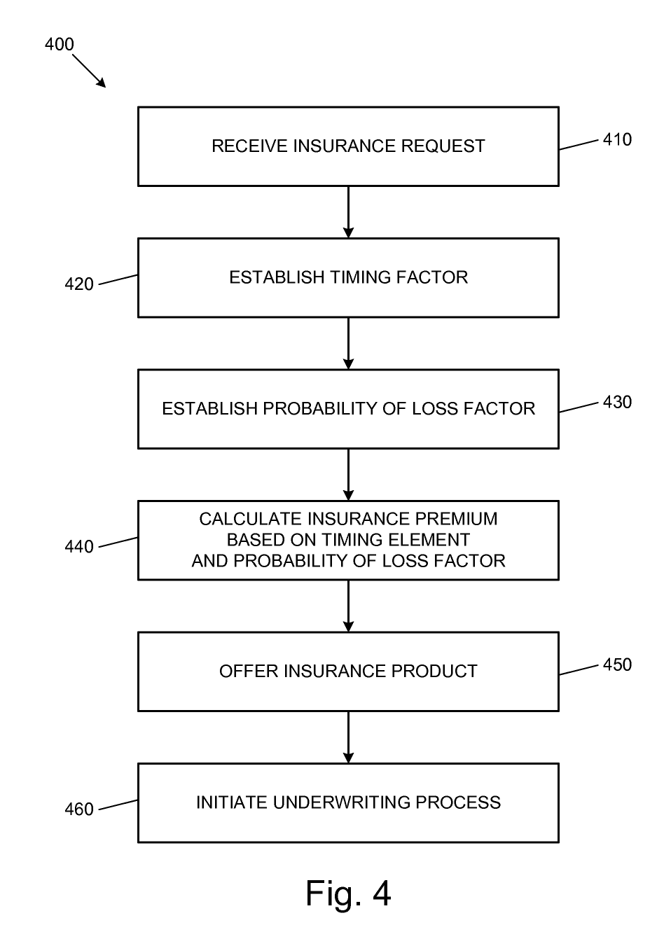

FIG. 4 illustrates a method 400 of providing an insurance product for a contingent liability, according to an exemplary embodiment of the present invention. At 410, a request for insurance can be received from a requesting part, including information about a contingent liability sought to be insured. At 420, a value of a timing factor is established. For example, this value can be calculated by the insurance system 100 based on information provided by an insurance agent or other entity, and based on analysis of one or more characteristics relevant to the term of the contingent liability. At 430, a value can be established for the probability of loss factor. At 440, an insurance premium can be calculated based on the timing factor and the probability of loss factor. At 450, an insurance product, including the insurance premium, to cover the contingent liability can be offered to the requesting party. At 460, if the insurance product is accepted by the requesting party, an underwriting process for the insurance product can be initiated.

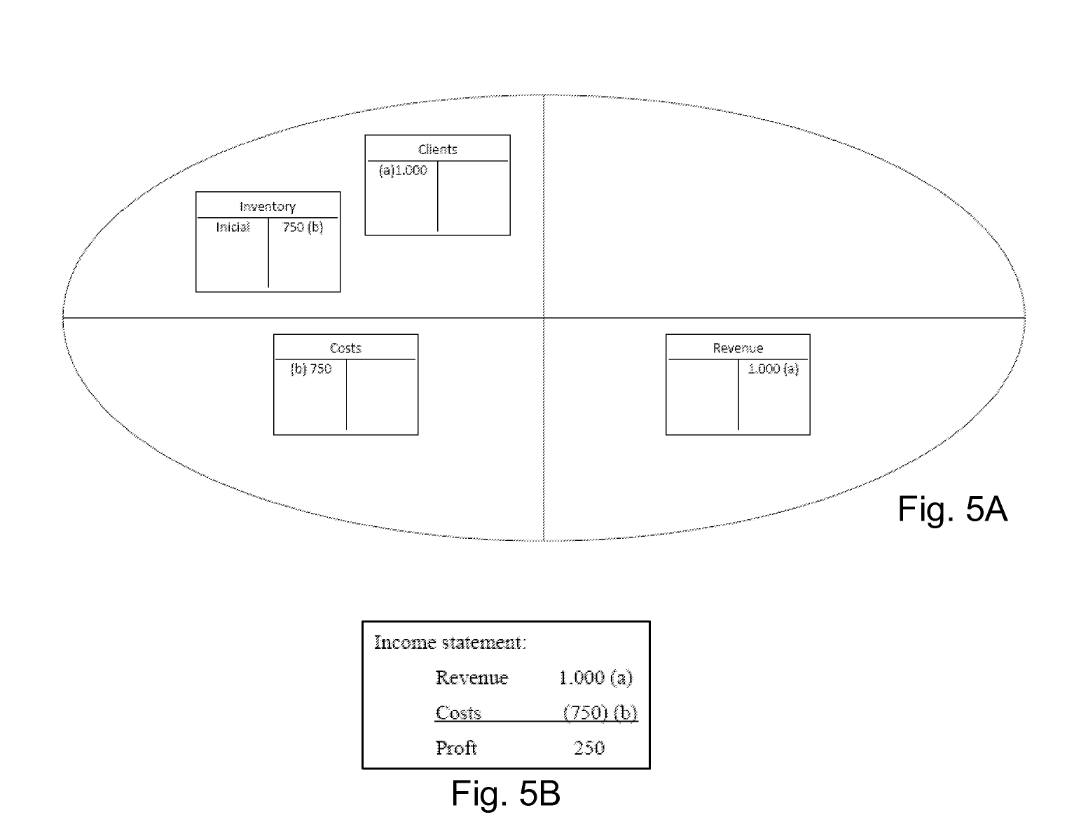

FIGS. 5A-10B illustrate various financial situations of a hypothetical company having a contingent liability insurable by various embodiments of the present invention. Each of FIGS. 5A, 6A, 7A, 8A, 9A, and 10A graphically illustrates a financial scenario, and FIGS. 5B, 6B, 7B, 8B, 9B, and 10B provide income statements corresponding to the financial scenarios. Each T-chart shown in the graphically-represented scenarios of FIGS. 5A, 6A, 7A, 8A, 9A, and 10A includes one or more numbers on the left side representing debits, one or more numbers on the right side representing credits, or one or more debits on the left along with one or more credits on the right.

FIGS. 5A-5B illustrate an initial financial scenario of an exemplary company. As shown in FIGS. 5A-5B, the existence of clients provides revenue of 1000 units, and expenditures of 750 units are spent to supply an inventory. In this simplified scenario, no contingent liabilities are considered.

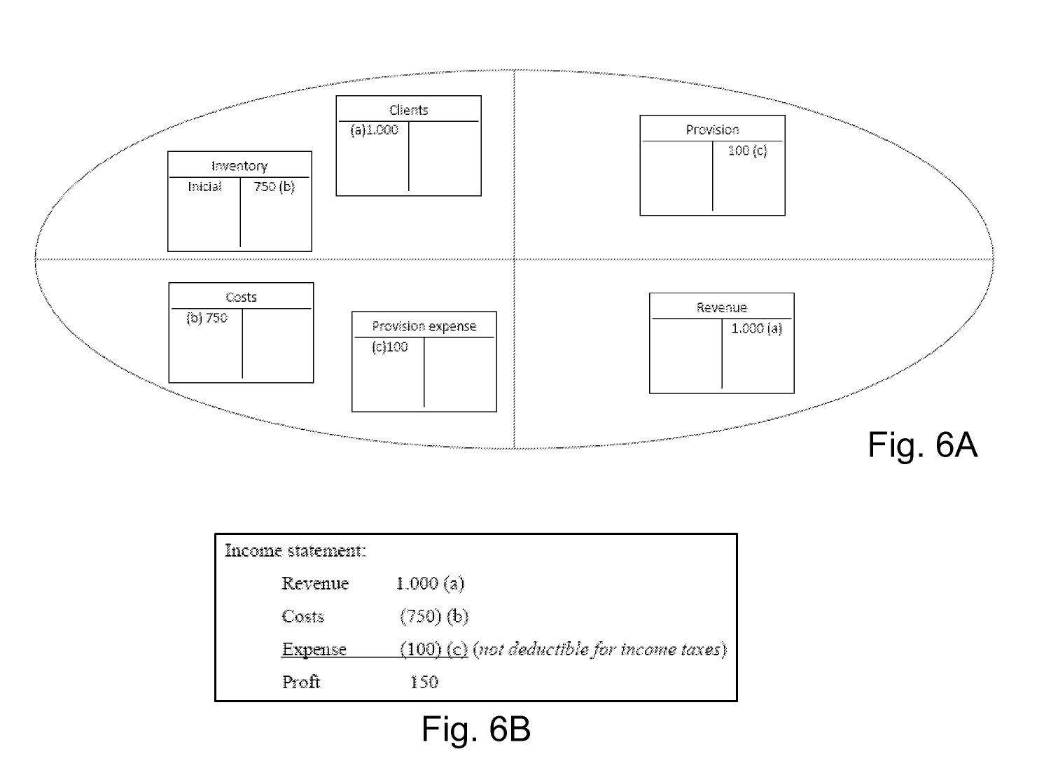

In FIGS. 6A-6B, the financial scenario of FIGS. 5A-5B is modified by the company's making a provision for a contingent liability. The provision has a value of 100 units, which is the reasonably estimable value of a probable contingent liability. If the contingent liability is deemed to be less than probable, or if the value of the potential obligation arising from the contingent liability is not reasonably estimable, then no accounting is traditionally made for the contingent liability. In the scenario of FIGS. 6A-6B, although a provision is made for the contingent liability, the provision is based on an uncertain future event. Accordingly, potential disbursements to shareholders will be reduced by the provision, even though the future obligation is uncertain.

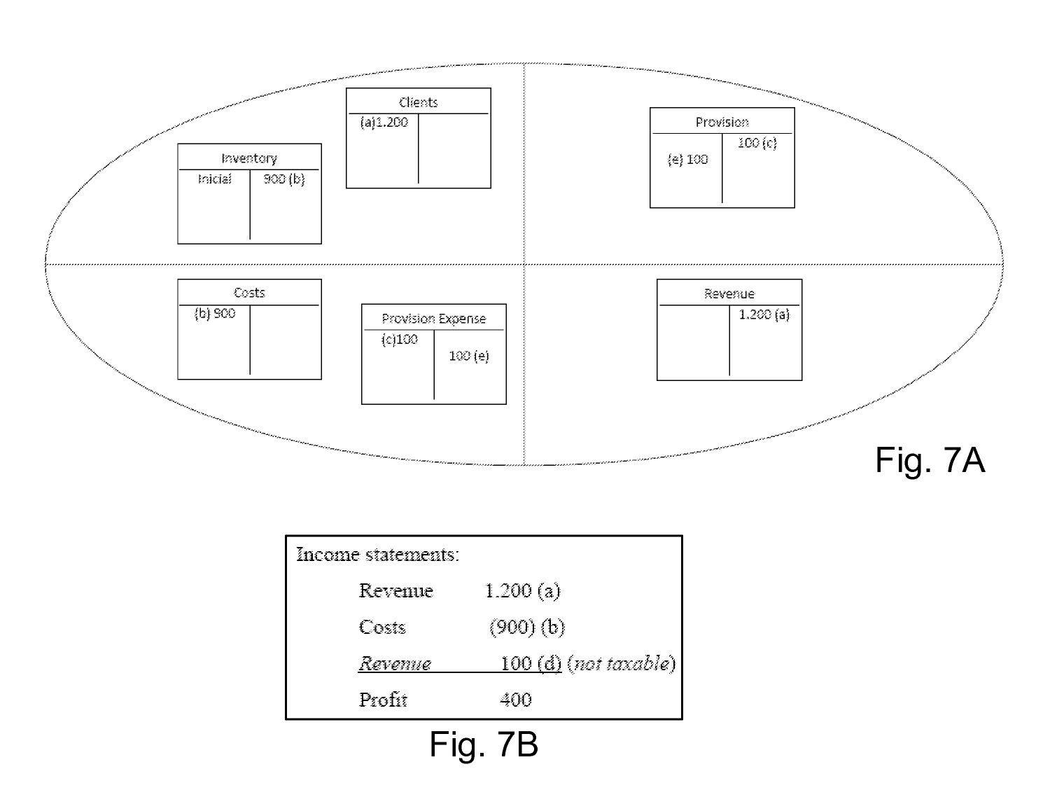

FIGS. 7A-7B illustrate how the company would traditionally modify its accounting after having made a provision for the contingent liability, if the contingency does not occur. As shown, the company traditionally reverses the provision, thus resulting in profits different from those originally expected and different from those on which shareholder distributions were based.

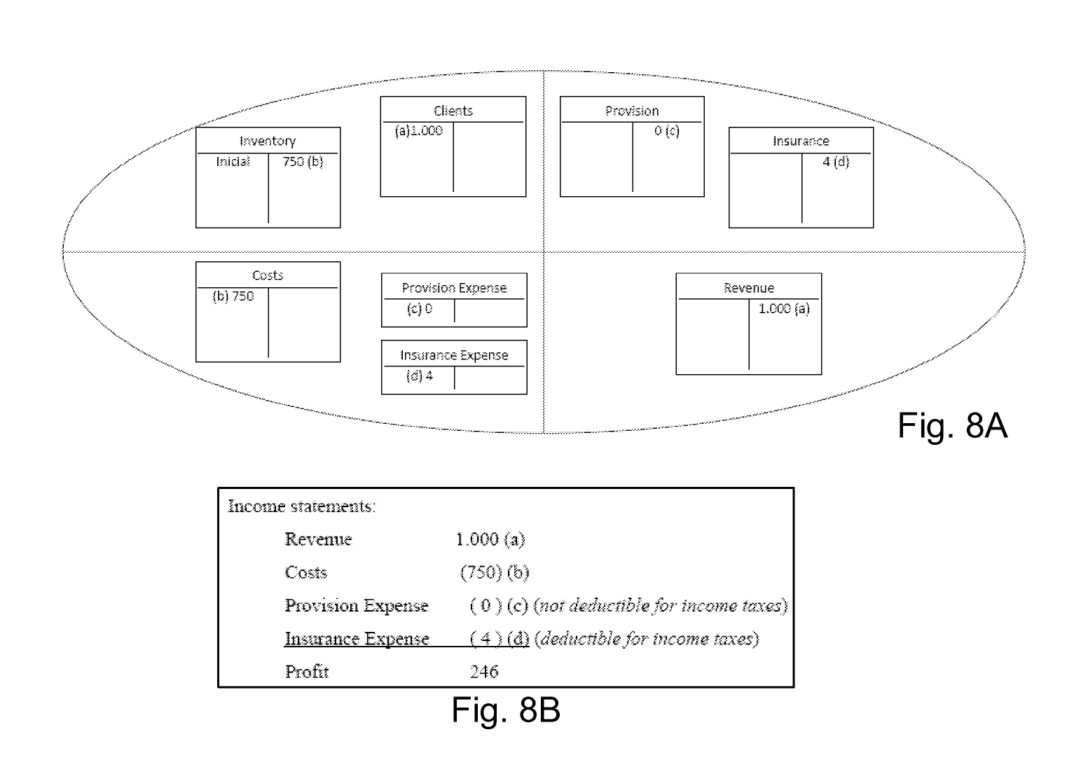

FIG. 8A-8B illustrates a modification of the scenario of FIGS. 6A-6B, where insurance is provided for the contingent liability, according to an exemplary embodiment of the present invention. As shown in FIGS. 8A-8B, the company pays 4 units to insure the contingent liability, and in return, the company receives insurance for the risks inherent in the contingent liability. When the company purchases an insurance product to cover the contingent liability, the insurer providing the insurance product assumes the risks associated with the contingency. Thus, the company need not make a provision for the contingent liability, and as shown in FIGS. 8A-8B, the provision expense is reduced to 0 units.

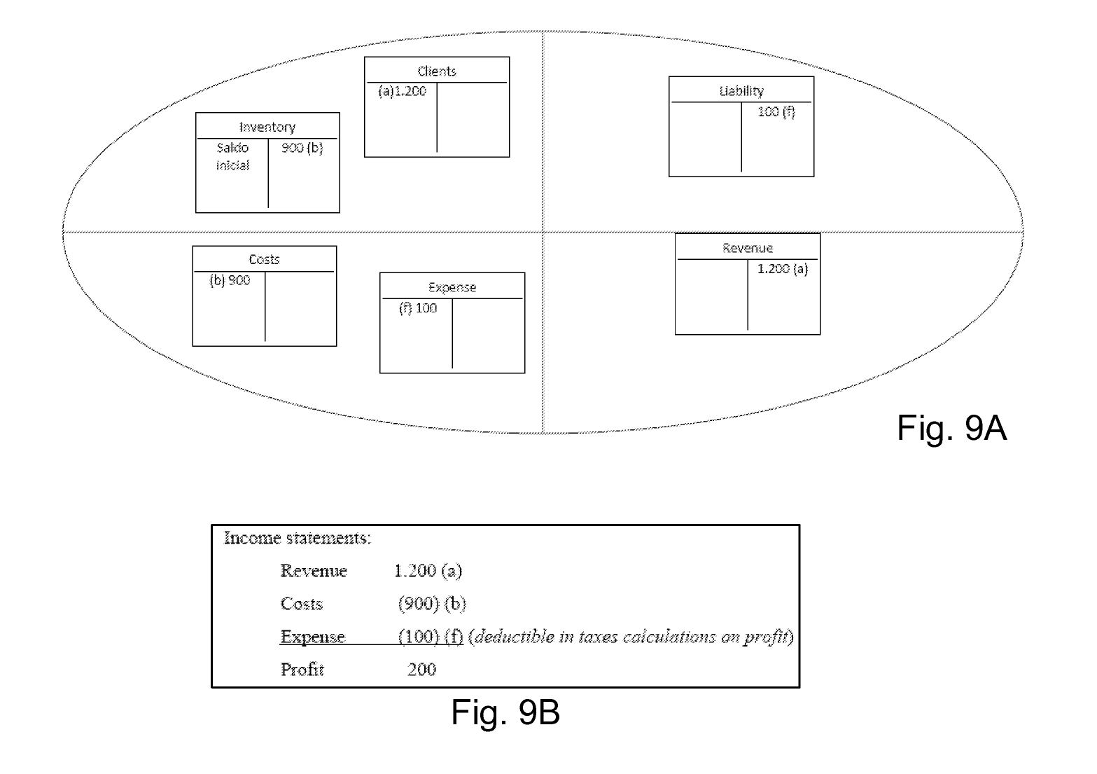

FIGS. 9A-9B illustrate a scenario occurring after the scenario of FIGS. 8A-8B, in which the contingency occurs, when the insurance product provides a right of recourse to the insurer, and that right of recourse is triggered by the contingency. In that case, the insurer may be allowed to recover from the company, even though the company is insured. Thus, as shown, the company can recognize an expense in the amount paid out to the insurer in accordance with the insurer's right of recourse. In this case, however, the expense is a certain and present obligation, so shareholder distributions will be made accurately.

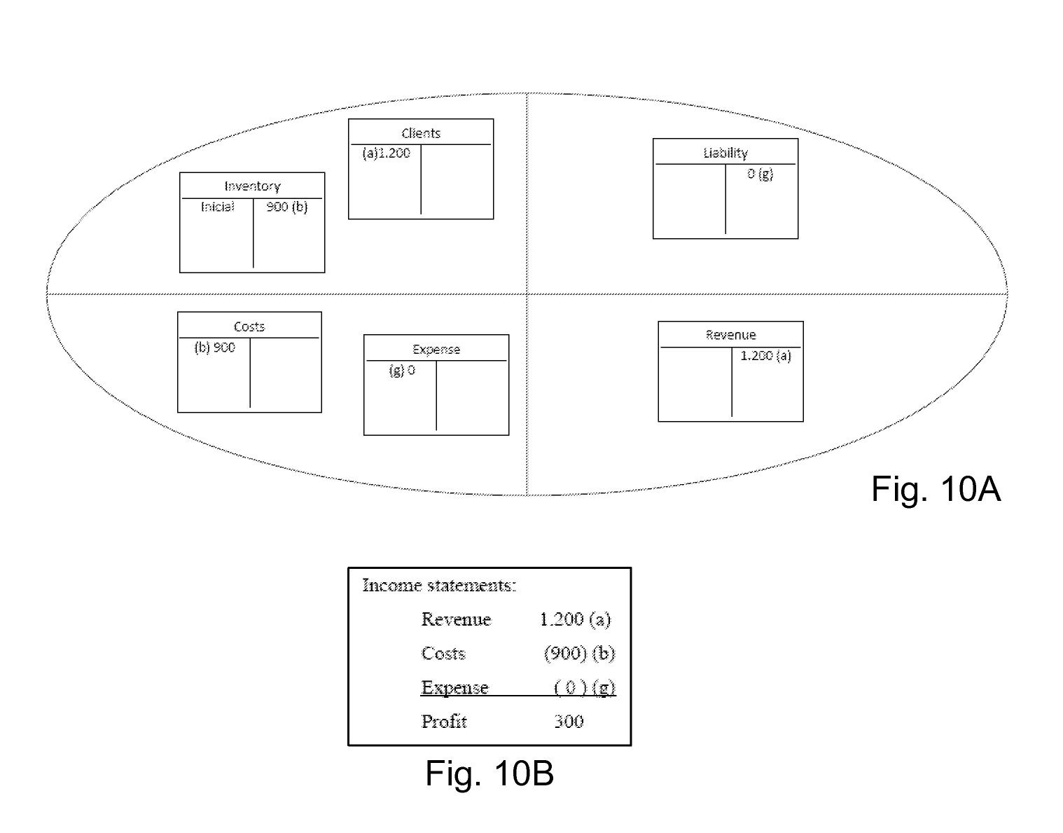

In some circumstances, no right of recourse is allowed or triggered, or the insurance product can enable the insurer to waive the right of recourse when the company pays an increased premium. FIGS. 10A-10B illustrate an example of such a circumstance, in which the contingency insured in FIGS. 8A-8B occurs, but the insurer has no right of recourse. As shown, the company pays no additional expense in light of the occurrence of the contingency, because the insurance product shields the company from the present obligation.

Accordingly, according to various embodiments of the present invention, insurance systems and methods can protect a company from unknowns inherent in contingent liabilities by providing insurance, thus enabling a company to accurately account for a contingent liability in the present.

While various embodiments of the insurance systems and methods have been disclosed in exemplary forms, many modifications, additions, and deletions can be made without departing from the spirit and scope of the invention and its equivalents, as set forth in claims to be filed in a later non-provisional application.

What is claimed is:

1. A method of providing an insurance product for a contingent liability comprising:
receiving, from a requesting entity, a description of a contingent liability;
calculating, with a computer processor, a premium for a proposed insurance product to cover the contingent liability; and
returning, to the requesting entity, terms of the proposed insurance product, the terms comprising the premium and a scope of coverage.

2. (canceled)

3. The method of claim 1, wherein calculating the premium for a proposed insurance product to cover the contingent liability comprises consideration of a timing factor and a probability of loss factor.

4. The method of claim 1, wherein the proposed insurance product is substitutable for a default provision on a balance sheet.

5. The method of claim 3, wherein calculating the premium comprises calculating a linear combination of the timing factor and the probability of loss factor.

6. The method of claim 3, the premium being variable based on changes to the timing factor or to the probability of loss factor.

7. The method of claim 6, further comprising recalculating the insurance premium in response to a change in one or more circumstances related to the contingent liability.

8. The method of claim 3, the timing factor being an estimate based on one or more similar contingent liabilities.

9. The method of claim 3, the probability factor being calculated based on one or more similar contingent liabilities.

10. The method of claim 3, wherein calculating the premium further comprises consideration of a maximum loss for the contingent liability.

11. The method of claim 1, the contingent liability being a first lawsuit.

12. The method of claim 11, wherein calculating a premium for a proposed insurance product to cover the first lawsuit comprises consideration of a timing factor and a probability of loss factor, the timing factor being calculated based on timings of one or more prior lawsuits, and the probability of loss factor being based on outcomes of the prior lawsuits.

13. The method of claim 1, wherein calculating the premium comprises:
calculating a tentative premium; and
receiving an adjustment to the tentative premium.

14. A system for providing an insurance product for a contingent liability comprising:
a client for receiving, from a requesting entity, a description of a contingent liability; and
a computer processor for calculating a premium for a proposed insurance product to cover the contingent liability;
the client being configured to return, to the requesting entity, terms of the proposed insurance product, the terms comprising the premium and a scope of coverage.

15. The system of claim 14, the computer processor being configured to execute computer-readable instructions for an algorithm to calculate the premium, the algorithm considering of a timing factor and a probability of loss factor.

16. The system of claim 15, the premium being variable based on changes to the timing factor or to the probability of loss factor.

17. The system of claim 14, the computer processor recalculating the insurance premium on a periodic basis.

18. The system of claim 14, the computer processor recalculating the insurance premium in response to a change in one or more circumstances related to the contingent liability.

19. The system of claim 14, the contingent liability being a first lawsuit.

20. The system of claim 19, the computer processor being configured to execute computer-readable instructions for an algorithm to calculate the premium, the algorithm considering a timing factor and a probability of loss factor, the timing factor being calculated based on timings of one or more prior lawsuits, and the probability of loss factor being based on outcomes of the prior lawsuits.

21. The system of claim 14, the computer processor being configured to calculate the premium by:
calculating a tentative premium; and
receiving an adjustment to the tentative premium.
